(19) United States
(12) Patent Application Publication
(10) Pub. No.: US 2026/0145938 A1
(43) Pub. Date: May 28, 2026

(54) PROCESSES AND APPARATUSES FOR TREATING NOX SEPARATED FROM CARBON DIOXIDE

(71) Applicant: UOP LLC, Des Plaines, IL (US)

(72) Inventors: Jeffrey Tyska, Roselle, IL (US); Xi Zhao, Arlington Heights, IL (US); Ling Zhou, Palatine, IL (US); Carl J. Stevens, Seaside, CA (US)

(21) Appl. No.: 18/960,243

(22) Filed: Nov. 26, 2024

(51) Int. Cl. C01B 21/04

(52) U.S. Cl. CPC C01B 21/0494; C01B 2210/0075

(57) ABSTRACT

Processes and apparatuses for treating NOx from a carbon dioxide stream. Prior to separating carbon dioxide and NOx, NOx is converted to nitrogen gas in an NOx conversion zone, which may include an SCR reactor and/or CO boiler. A carbon separation zone which may include one or more fractionation columns produces a CO₂ stream and an NOx stream. The NOx is passed back to the NOx conversion zone.

### FIELD OF THE INVENTION

This invention relates generally to processes and apparatuses for separating NOx from carbon dioxide.

### BACKGROUND OF THE INVENTION

Carbon dioxide (CO₂) capture from flue gas is a key decarbonization strategy for various industries, such as refineries and steel, power and cement producers. In cryogenic carbon capture from a flue gas or other source with NOx compounds present, separation of NOx from the captured CO₂ for sequestration or utilization is highly important.

For example, a fluidized catalytic cracking (FCC) unit may use synthetic air (oxygen/air and a portion of carbon dioxide recycle). For cryogenic capture of CO₂ from FCC units using synthetic air, NOx must be removed and disposed of. The separated NOx can be disposed of via mixing with flue gas and venting to atmosphere, fertilizer production, neutralization, treatment, or acid production.

While presumably effective for their intended purposes, these disposal processes require extra equipment or result in additional emissions to the environment. This problem of this requirement is increased by the small size of the NOx waste stream.

Accordingly, it would be desirable to have more effective and efficient ways to dispose of or utilize the NOx separated from the CO₂ in a carbon capture unit.

### SUMMARY OF THE INVENTION

The present inventors have discovered processes and apparatuses for efficiently disposing of or utilizing NOx separated from the CO₂ in a carbon capture unit. In particular, the present processes and apparatuses require less equipment than conventional solutions. Specifically, according to the present invention, the existing equipment is utilized to convert NOx into nitrogen without additional catalyst or treating equipment.

The present processes and apparatuses are believed to be particularly beneficial in FCC units that utilize synthetic air. NOx that is separated out downstream of the SCR may be recycled back to the FCC regenerator or a CO boiler inlet to increase the reaction of NOx precursors prior to the SCR itself. This can minimize the ammonia needed for the SCR, or even preclude the need for the SCR entirely.

Accordingly, the present invention may be characterized, in at least one aspect, as providing a process for treating NOx from a carbon dioxide stream by: converting NOx from a feed stream comprising carbon dioxide into nitrogen gas in a NOx conversion zone, and produce an NOx depleted effluent stream, the NOx depleted effluent stream having a lower amount of NOx compared to the feed stream; separating NOx from carbon dioxide in the NOx depleted effluent stream effluent stream in a carbon separation zone into a carbon dioxide enriched stream and a NOx enriched stream; and converting NOx from the NOx enriched stream into nitrogen in the NOx conversion zone or an FCC unit.

The NOx conversion zone may include a selective catalytic reaction (SCR) reactor and the SCR reactor may be configured to receive a stream of ammonia or ammonia generating material. The NOx enriched stream may be recycled to the SCR reactor.

The feed stream may include a flue gas steam from an FCC regeneration zone of the FCC unit. The NOx enriched stream may be recycled to the FCC regeneration zone.

The NOx conversion zone may include a combustion zone with a boiler configured to combust fuel gas to convert carbon monoxide to carbon dioxide. The NOx enriched stream may be recycled to the combustion zone.

The carbon separation zone may include one or more fractionation columns configured to separate NOx from carbon dioxide.

In another aspect the present invention may be broadly characterized as providing a process for treating NOx from a carbon dioxide stream by: passing a feed stream comprising carbon dioxide and NOx to a NOx conversion zone, the NOx conversion zone configured to produce a NOx depleted effluent stream, the NOx depleted effluent stream having a lower amount of NOx compared to the feed stream; passing the NOx depleted effluent stream to a carbon separation zone, the carbon separation zone configured to separate NOx from carbon dioxide in the NOx depleted effluent stream into a carbon dioxide enriched stream and a NOx enriched stream; and passing the NOx from the NOx enriched stream to the NOx conversion zone.

The process may also include passing the NOx depleted effluent stream to a scrubbing zone to remove sulfur compounds before the NOx depleted effluent stream is passed to the carbon separation zone

The NOx conversion zone may include an SCR reactor, and the process may include passing the NOx from the NOx enriched stream to the NOx conversion zone by passing the NOx enriched stream to the SCR reactor as a recycle stream.

The feed stream may be a flue gas steam from an FCC regeneration zone. In the process, passing the NOx from the NOx enriched stream to the NOx conversion zone may include passing the NOx enriched stream to the FCC regeneration zone.

The NOx conversion zone may include a combustion zone with a boiler, and the process may also include combusting fuel gas in the combustion zone to convert carbon monoxide to carbon dioxide. The NOx enriched stream may be recycled to the combustion zone. The carbon separation zone may include one or more fractionation columns.

In a further aspect, the present invention may be generally characterized as providing an apparatus for removing NOx from a carbon dioxide stream which has: a NOx conversion zone, the NOx conversion zone configured to produce a NOx depleted effluent stream, the NOx depleted effluent stream having a lower amount of NOx compared to the feed stream; a carbon separation zone, the carbon separation zone configured to receive the NOx depleted effluent stream and separate NOx from carbon dioxide into a carbon dioxide enriched stream and a NOx enriched stream; and a line configured to pass the NOx from the NOx enriched stream to the NOx conversion zone.

The carbon separation zone may include one or more fractionation columns.

The NOx conversion zone may include an SCR reactor and the line may be configured to pass the NOx from the NOx enriched stream to the SCR reactor.

The NOx conversion zone may include a CO boiler and the line may be configured to pass the NOx from the NOx enriched stream to the CO boiler.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

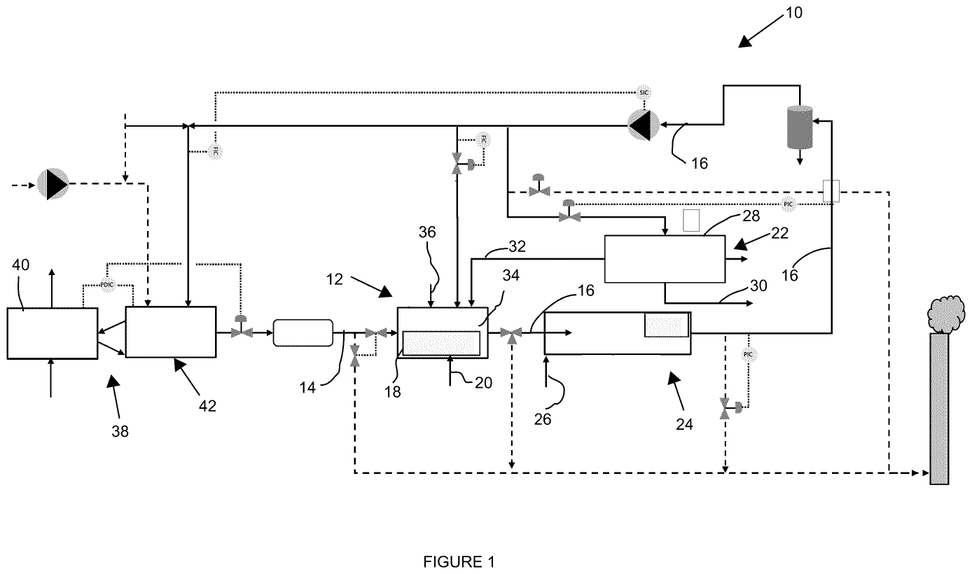

FIG. 1 shows a process flow diagram according to one or more aspects of the present invention.

It should be appreciated and understood by those of ordinary skill in the art that various other components such as valves, pumps, filters, coolers, etc. were not shown in the drawings as it is believed that the specifics of same are well within the knowledge of those of ordinary skill in the art and a description of same is not necessary for practicing or understating the embodiments of the present invention. In general, the same reference numbers will be used throughout the drawing(s) and accompanying written description to refer to the same or like parts.

### DETAILED DESCRIPTION OF THE INVENTION

As mentioned above, processes and apparatuses for processing NOx separated from carbon dioxide stream have been invented. For example, an FCC regenerator, running in partial regeneration mode, creates low levels of NO and high levels of NOx precursors (NH₃+HCN) in the presence of CO. The NOx precursors convert to NOx in a CO boiler, which may then be treated in the SCR for additional NOx removal. Any NOx remaining after NOx reduction may be partially split into various streams that mostly contain carbon dioxide. At least a portion of these is passed to a carbon capture unit which may include one or more low temperature (i.e., cryogenic) fractionation columns. The fractionation column(s) produce a CO₂ steam to be treated as desired and, in some cases, may produce a liquid NOx rich stream. The NOx rich steam may be sent back to the SCR, the regenerator, or the CO boiler. Fundamentally, all these options result in the reduction of NOx to nitrogen gas via reaction with ammonia, however the latter two destinations better utilize ammonia generated in the FCC process itself to reduce NOx.

With these general principles in mind, one or more embodiments of the present invention will be described with the understanding that the following description is not intended to be limiting.

As shown in FIG. 1, an apparatus 10 optionally having a NOx conversion zone 12 receives a feed stream 14. The feed stream 14 includes carbon dioxide and NOx compounds. As used herein “NOx” and “NOx compounds” include one or more of NO, NO₂, N₂O, N₂O₃, and N₂O₄. In the NOx conversion zone 12, the NOx is converted to nitrogen gas (N2). Thus, the NOx conversion zone 12 produces an NOx depleted effluent stream 16 having a lower amount of NOx compared to the feed stream 14.

The NOx conversion zone 12 may comprise a selective catalytic reduction (SCR) reactor 18 to form the NOx depleted effluent stream 16 with a reduced level of nitrogen oxide-containing compounds compared to the feed stream 14. Any suitable SCR catalyst could be used, including but not limited to, ceramic carrier materials such as titanium oxide with active catalytic components such as oxides of base metals including TiO₂, WO₃ and V₂O₅, or an activated carbon-based catalyst. An ammonia and/or urea stream 20 is introduced into the reactor 18 where it reacts with the NOx present in the feed stream 14. The selective catalytic reduction (SCR) reactor is merely an example of a NOx conversion zone 12.

All, or a portion, of the NOx depleted effluent stream 16 from the NOx conversion zone 12 is passed to a carbon separation zone 22. However, before being passed to the carbon separation zone 22, the NOx depleted effluent stream 16 may be passed to a scrubbing zone 24 to remove/reduce sulfur, chlorine and fluorine containing compounds. The scrubbing zone 24 may be a wet scrubbing zone which, as is known, receives water and a caustic stream 26.

In the carbon separation zone 22, carbon dioxide and NOx are separated. For example, the carbon separation zone 22 may include one or more fractionation columns 28 which will separate the components of the NOx depleted effluent stream 16 into a carbon dioxide enriched stream 30 and a NOx enriched stream 32. The carbon dioxide enriched stream 30 may be processed and/or stored as desired. In contrast to conventional processes and apparatuses, the NOx in the NOx enriched stream 32 is converted into nitrogen in the NOx conversion zone 12, or in an FCC unit (discussed below).

Accordingly, if the NOx conversion zone 12 includes an SCR reactor 18, it is contemplated that the NOx enriched stream 32 could be recycled to the SCR reactor 18. This location, however, will increase the ammonia/urea injection 20 accordingly.

Similarly, if the NOx conversion zone 12 includes a CO boiler 34, which is configured to combust fuel gas 36 to convert carbon monoxide to carbon dioxide, the NOx enriched stream 32 may be recycled to the CO boiler 34. Within the CO boiler 34, ammonia will be formed which, similar to the reactions in the SCR reactor 18, will convert the NOx into nitrogen gas and will reduce the required conversion downstream due to the conversion of HCN to NH₃ in the CO boiler.

As noted at the outset, the present invention is believed to be particularly advantageous when used with an FCC unit 38. As is known, the FCC unit 38 typically includes an FCC reactor 40 and a regeneration zone 42 having a regeneration reactor that produces a flue gas. The flue gas from the FCC regeneration zone 42 may form the feed stream 14 for the NOx conversion zone 12. Additionally, when the present invention is utilized in connection with an FCC unit 38 having the regeneration zone 42, the NOx enriched stream 32 may be recycled back to the FCC regeneration zone 42. The NH₃ and HCN created in the FCC regeneration zone 42 will help reduce the NOx concentrations that must be treated or removed downstream. Partial combustion FCC units will also typically include the CO boiler 34 as mentioned above.

In any configuration, the present processes and apparatuses do not require the extra equipment and processing units to manage an NOx enriched stream produced by the carbon separation zone.

### EXPERIMENTS

### Example 1: NO₂ Rejection from CO₂ Separation Zone

A process simulation of CO₂ purification was conducted. A feed gas stream with composition shown in Table 1 below is pre-treated to remove moisture, compressed and cooled to adequate temperature for liquid CO₂ fractionation. The pre-treated stream is fractionated in a first column to reject most of the NOx presented as a NOx stream and produce a first-intermediate feed stream. The first-intermediate feed stream is then fractionated in a second fractionation column to reject non-condensing permanent gas and a second-intermediate feed stream. The second-intermediate feed stream then pass through a third fractionation column to produce a CO₂ product stream and a raffinate stream, The raffinate stream is recycled to the first column. The conditions of separation are optimized such that the NOx stream and CO₂ Product stream reach compositions shown in TABLE 1.

TABLE 1
Feed Gas Composition to CO₂ Separation Unit

| Composition | Feed Gas | | NOx Stream | | CO₂ Product | |
|---|---|---|---|---|---|---|
| CO₂ | 87.6 | mol % | 93.0 | mol % | 99.999 | mol % |

| | | | | | |
|---|---|---|---|---|---|
| N₂ | 1.8 | mol % | Trace | 0.001 | mol % |

| O₂ | 2.0 | mol % | | |
|---|---|---|---|---|
| H₂O | 5.6 | mol % | 0.16 | mol % |
| CO | 0.07 | mol % | | |
| Ar | 2.9 | mol % | | |
| NOx | 58 | ppm | 6.45 | mol % |

| | | | |
|---|---|---|---|
| SO₂ | Trace | 0.17 | mol % |

It can be seen from the above example that low level of NOx in a CO₂-rich stream could be significantly enriched to form a NOx stream, which can be optimally treated elsewhere.

### Example 2: Treatment of Rejected NOx Stream

A process simulation of FCC regeneration with CO₂ capture is conducted. The process operates with flue gas recycle, as described in FIG. 1. The regenerator operates in partial-combustion mode and flue gas from regenerator is further combusted in a CO boiler with SCR. The CO boiler effluent is further treated in a scrubbing zone, re-compressed and split into a CO₂ capture feed stream and a recycled flue gas stream. The recycled flue gas stream is further split into a regenerator RG stream and a CO boiler RG stream to control the operation of FCC regenerator and CO boiler. The CO₂ capture feed stream passes through a CO₂ separation zone which operates at equivalent condition to those determined in Example 1. A NOx stream is returned by the CO₂ separation zone to the CO boiler. At steady state operation, the following compositions shown in TABLE 2 are reached.

TABLE 2
Gas Composition in FCC regeneration with CO₂ capture

| Composition | Regenerator | | NOx Stream from | | CO₂ capture | |
|---|---|---|---|---|---|---|
| (Dry Basis) | Flue Gas | | CO₂ separation zone | | feed stream | |
| CO₂ | 85.5 | mol % | 93.2 | mol % | 94.2 | mol % |
| N₂ | 1.8 | mol % | | | 1.3 | mol % |
| O₂ | 0.5 | mol % | | | 1.7 | mol % |
| CO | 9.1 | mol % | | | 0.037 | mol % |
| Ar | 2.9 | mol % | | | 2.8 | mol % |
| NOx | 13 | ppm | 6.67 | mol % | 30 | ppm |

| NOx precursor | 433 | ppm | 0 | | 0 |
|---|---|---|---|---|---|
| Other | 0.15 | mol % | 0.13 | mol % | |

Results above showed that the configuration effectively reduced NOx emission by FCC regeneration operation.

### SPECIFIC EMBODIMENTS

While the following is described in conjunction with specific embodiments, it will be understood that this description is intended to illustrate and not limit the scope of the preceding description and the appended claims.

A first embodiment of the invention is a process for treating NOx from a carbon dioxide stream, the process comprising converting NOx from a feed stream comprising carbon dioxide into nitrogen gas in a NOx conversion zone, and produce an NOx depleted effluent stream, the NOx depleted effluent stream having a lower amount of NOx compared to the feed stream; separating NOx from carbon dioxide in the NOx depleted effluent stream effluent stream in a carbon separation zone into a carbon dioxide enriched stream and a NOx enriched stream; and converting NOx from the NOx enriched stream into nitrogen in the NOx conversion zone or an FCC unit. An embodiment of the invention is one, any or all of prior embodiments in this paragraph up through the first embodiment in this paragraph, wherein the NOx conversion zone comprises a selective catalytic reaction (SCR) reactor, the SCR reactor configured to receive a stream of ammonia or ammonia generating material. An embodiment of the invention is one, any or all of prior embodiments in this paragraph up through the first embodiment in this paragraph, wherein the NOx enriched stream is recycled to the SCR reactor. An embodiment of the invention is one, any or all of prior embodiments in this paragraph up through the first embodiment in this paragraph, wherein the feed stream comprises a flue gas steam from an FCC regeneration zone of the FCC unit. An embodiment of the invention is one, any or all of prior embodiments in this paragraph up through the first embodiment in this paragraph, wherein the NOx enriched stream is recycled to the FCC regeneration zone. An embodiment of the invention is one, any or all of prior embodiments in this paragraph up through the first embodiment in this paragraph, wherein the NOx conversion zone comprises a combustion zone with a boiler configured to combust fuel gas to convert carbon monoxide to carbon dioxide. An embodiment of the invention is one, any or all of prior embodiments in this paragraph up through the first embodiment in this paragraph, wherein the NOx enriched stream is recycled to the combustion zone. An embodiment of the invention is one, any or all of prior embodiments in this paragraph up through the first embodiment in this paragraph, wherein the carbon separation zone comprises one or more fractionation columns configured to separate NOx from carbon dioxide.

A second embodiment of the invention is a process for treating NOx from a carbon dioxide stream, the process comprising passing a feed stream comprising carbon dioxide and NOx to a NOx conversion zone, the NOx conversion zone configured to produce a NOx depleted effluent stream, the NOx depleted effluent stream having a lower amount of NOx compared to the feed stream; passing the NOx depleted effluent stream to a carbon separation zone, the carbon separation zone configured to separate NOx from carbon dioxide in the NOx depleted effluent stream into a carbon dioxide enriched stream and a NOx enriched stream; and passing the NOx from the NOx enriched stream to the NOx conversion zone. An embodiment of the invention is one, any or all of prior embodiments in this paragraph up through the second embodiment in this paragraph, further comprising passing the NOx depleted effluent stream to a scrubbing zone to remove sulfur compounds before the NOx depleted effluent stream is passed to the carbon separation zone An embodiment of the invention is one, any or all of prior embodiments in this paragraph up through the second embodiment in this paragraph, wherein the NOx conversion zone comprises an SCR reactor, and wherein the process includes passing the NOx from the NOx enriched stream to the NOx conversion zone comprises passing the NOx enriched stream to the SCR reactor as a recycle stream. An embodiment of the invention is one, any or all of prior embodiments in this paragraph up through the second embodiment in this paragraph, wherein the feed stream comprises a flue gas steam from an FCC regeneration zone. An embodiment of the invention is one, any or all of prior embodiments in this paragraph up through the second embodiment in this paragraph, wherein passing the NOx from the NOx enriched stream to the NOx conversion zone comprises passing the NOx enriched stream to the FCC regeneration zone. An embodiment of the invention is one, any or all of prior embodiments in this paragraph up through the second embodiment in this paragraph, wherein the NOx conversion zone comprises a combustion zone with a boiler, and wherein the process further comprises combusting fuel gas in the combustion zone to convert carbon monoxide to carbon dioxide. An embodiment of the invention is one, any or all of prior embodiments in this paragraph up through the second embodiment in this paragraph, wherein the NOx enriched stream is recycled to the combustion zone. An embodiment of the invention is one, any or all of prior embodiments in this paragraph up through the second embodiment in this paragraph, wherein the carbon separation zone comprises one or more fractionation columns.

A third embodiment of the invention is an apparatus for removing NOx from a carbon dioxide stream, the apparatus comprising a NOx conversion zone, the NOx conversion zone configured to produce a NOx depleted effluent stream, the NOx depleted effluent stream having a lower amount of NOx compared to the feed stream; a carbon separation zone, the carbon separation zone configured to receive the NOx depleted effluent stream and separate NOx from carbon dioxide into a carbon dioxide enriched stream and a NOx enriched stream; and a line configured to pass the NOx from the NOx enriched stream to the NOx conversion zone. An embodiment of the invention is one, any or all of prior embodiments in this paragraph up through the third embodiment in this paragraph, wherein the carbon separation zone comprises one or more fractionation columns. An embodiment of the invention is one, any or all of prior embodiments in this paragraph up through the third embodiment in this paragraph, wherein the NOx conversion zone comprises an SCR reactor, the line configured to pass the NOx from the NOx enriched stream to the SCR reactor. An embodiment of the invention is one, any or all of prior embodiments in this paragraph up through the third embodiment in this paragraph, wherein the NOx conversion zone comprises a CO boiler, the line configured to pass the NOx from the NOx enriched stream to the CO boiler.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process for treating NOx from a carbon dioxide stream, the process comprising:
converting NOx from a feed stream comprising carbon dioxide into nitrogen gas in a NOx conversion zone, and produce an NOx depleted effluent stream, the NOx depleted effluent stream having a lower amount of NOx compared to the feed stream;
separating NOx from carbon dioxide in the NOx depleted effluent stream effluent stream in a carbon separation zone into a carbon dioxide enriched stream and a NOx enriched stream; and
converting NOx from the NOx enriched stream into nitrogen in the NOx conversion zone or an FCC unit.

2. The process of claim 1, wherein the NOx conversion zone comprises a selective catalytic reaction (SCR) reactor, the SCR reactor configured to receive a stream of ammonia or ammonia generating material.

3. The process of claim 2, wherein the NOx enriched stream is recycled to the SCR reactor.

4. The process of claim 1, wherein the feed stream comprises a flue gas steam from an FCC regeneration zone of the FCC unit.

5. The process of claim 4, wherein the NOx enriched stream is recycled to the FCC regeneration zone.

6. The process of claim 1, wherein the NOx conversion zone comprises a combustion zone with a boiler configured to combust fuel gas to convert carbon monoxide to carbon dioxide.

7. The process of claim 6, wherein the NOx enriched stream is recycled to the combustion zone.

8. The process of claim 1, wherein the carbon separation zone comprises one or more fractionation columns configured to separate NOx from carbon dioxide.

9. A process for treating NOx from a carbon dioxide stream, the process comprising:
passing a feed stream comprising carbon dioxide and NOx to a NOx conversion zone, the NOx conversion zone configured to produce a NOx depleted effluent stream, the NOx depleted effluent stream having a lower amount of NOx compared to the feed stream;
passing the NOx depleted effluent stream to a carbon separation zone, the carbon separation zone configured to separate NOx from carbon dioxide in the NOx depleted effluent stream into a carbon dioxide enriched stream and a NOx enriched stream; and
passing the NOx from the NOx enriched stream to the NOx conversion zone.

10. The process of claim 9, further comprising:
passing the NOx depleted effluent stream to a scrubbing zone to remove sulfur compounds before the NOx depleted effluent stream is passed to the carbon separation zone.

11. The process of claim 9, wherein the NOx conversion zone comprises an SCR reactor, and wherein the process includes passing the NOx from the NOx enriched stream to the NOx conversion zone comprises passing the NOx enriched stream to the SCR reactor as a recycle stream.

12. The process of claim 9, wherein the feed stream comprises a flue gas steam from an FCC regeneration zone.

13. The process of claim 12, wherein passing the NOx from the NOx enriched stream to the NOx conversion zone comprises passing the NOx enriched stream to the FCC regeneration zone.

14. The process of claim 9, wherein the NOx conversion zone comprises a combustion zone with a boiler, and wherein the process further comprises:
combusting fuel gas in the combustion zone to convert carbon monoxide to carbon dioxide.

15. The process of claim 14, wherein the NOx enriched stream is recycled to the combustion zone.

16. The process of claim 9, wherein the carbon separation zone comprises one or more fractionation columns.

17. An apparatus for removing NOx from a carbon dioxide stream, the apparatus comprising:
a NOx conversion zone, the NOx conversion zone configured to produce a NOx depleted effluent stream, the NOx depleted effluent stream having a lower amount of NOx compared to the feed stream;
a carbon separation zone, the carbon separation zone configured to receive the NOx depleted effluent stream and separate NOx from carbon dioxide into a carbon dioxide enriched stream and a NOx enriched stream; and
a line configured to pass the NOx from the NOx enriched stream to the NOx conversion zone.

18. The apparatus of claim 17, wherein the carbon separation zone comprises one or more fractionation columns.

19. The apparatus of claim 17, wherein the NOx conversion zone comprises an SCR reactor, the line configured to pass the NOx from the NOx enriched stream to the SCR reactor.

20. The apparatus of claim 17, wherein the NOx conversion zone comprises a CO boiler, the line configured to pass the NOx from the NOx enriched stream to the CO boiler.
